(19) United States
(12) Patent Application Publication
(10) Pub. No.: US 2019/0172487 A1
(43) Pub. Date: Jun. 6, 2019

(54) ALUMINUM ALLOY PLATE FOR MAGNETIC DISC SUBSTRATE, METHOD FOR PRODUCING THE SAME, AND MAGNETIC DISC

(71) Applicants: UACJ CORPORATION, Tokyo (JP); FURUKAWA ELECTRIC CO., LTD., Tokyo (JP)

(72) Inventors: Kotaro KITAWAKI, Tokyo (JP); Takuya MURATA, Tokyo (JP); Akira HIBINO, Tokyo (JP); Naoki KITAMURA, Tokyo (JP); Hiroki OTA, Tokyo (JP); Yasuo FUJII, Tokyo (JP); Hideki TAKAHASHI, Tokyo (JP); Takashi MORI, Tokyo (JP)

(21) Appl. No.: 16/265,884

(22) Filed: Feb. 1, 2019

Related U.S. Application Data
(63) Continuation of application No. PCT/JP2017/027483, filed on Jul. 28, 2017.

(30) Foreign Application Priority Data
Aug. 1, 2016 (JP) 2016-150998

(51) Int. Cl. G11B 5/73; C22F 1/047; C22C 21/08; C22C 1/02

(52) U.S. Cl. CPC G11B 5/7315; C22C 1/026; C22C 21/08; C22F 1/047

(57) ABSTRACT

An aluminum alloy plate for a magnetic disc substrate according to the present disclosure includes, in mass %, Mg: 3.0 to 8.0%, Cu: 0.002 to 0.150%, Zn: 0.05 to 0.60%, Fe: 0.001 to 0.060%, Si: 0.001 to 0.060%, Be: 0.00001 to 0.00200%, Cr: 0.200% or less, Mn: 0.500% or less, and Cl: 0.00300% or less, with the balance being Al and inevitable impurities, and an abundance of a Cr oxide having a maximum diameter of 3 to 10 μm observed in a metal structure is 1 or less per single side of a disc.

### CROSS REFERENCE TO RELATED APPLICATIONS

The present application is a continuation application of International Patent Application No. PCT/JP2017/027483 filed on Jul. 28, 2017, which claims priority to Japanese Patent Application No. 2016-150998, filed on Aug. 1, 2016. The contents of these applications are incorporated herein by reference in their entirety.

### BACKGROUND

### Technical Field

The present disclosure relates to an aluminum alloy plate for a magnetic disc substrate, which provides excellent plated surface smoothness after plating layer formation, a method for producing the aluminum alloy plate for a magnetic disc substrate, and a magnetic disc prepared using the aluminum alloy plate.

### Background Art

An aluminum alloy magnetic disc used in a storage device for a computer is produced from an aluminum alloy substrate having good plating properties as well as excellent mechanical properties and excellent processability. Examples of the aluminum alloy substrate include an aluminum alloy substrate made of a JIS 5086 alloy (Mg: 3.5 to 4.5 mass %, Fe≤0.50 mass %, Si≤0.40 mass %, Mn: 0.20 to 0.70 mass %, Cr: 0.05 to 0.25 mass %, Cu≤0.10 mass %, Ti≤0.15 mass %, and Zn≤0.25 mass %, with the balance being Al and inevitable impurities), an aluminum alloy substrate having the content of Fe, Si, or the like, which are impurities in a JIS 5086 alloy, restricted to render an intermetallic compound in a matrix small, and an aluminum alloy substrate having Cu or Zn added thereto to thereby improve the plating properties.

A general magnetic disc made of an aluminum alloy is produced by first preparing a circular aluminum alloy substrate, plating the circular aluminum alloy substrate, and then attaching a magnetic material to the substrate surface.

In general, a magnetic disc having a circular aluminum alloy substrate is produced by the following steps: First, an aluminum alloy is cast to produce an ingot, and the ingot is hot rolled and then cold rolled. The ingot is annealed as necessary, to produce a rolled material. Subsequently, the rolled material is punched into a circular shape, and a plurality of the punched circular aluminum alloy plates are stacked. The stack is subjected to pressure annealing where the stack is annealed while pressure is applied to the stack from top and bottom to flatten the stack. After that, by releasing the stack state, a circular aluminum alloy substrate is prepared.

The circular aluminum alloy substrate thus prepared is subjected to cutting, grinding, degreasing, etching, and zincating (Zn substitution treatment) as a pre-treatment. Then, on the surface of the zincated circular aluminum alloy substrate, a plating layer made of Ni—P, which are hard nonmagnetic metals, is formed by an electroless plating method as a base treatment. The surface of the Ni—P plating layer is polished, and a magnetic layer is then formed by a sputtering method to produce a magnetic disc.

Recently, it has been desired that magnetic discs have a larger capacity and a higher density due to the needs for multimedia or the like, and a surface memory density of 2 Tb/in² will be achieved in the near future. In order to increase the memory density of a magnetic disc, the smoothness of the surface of the magnetic disc, which may cause errors when the data are read, is necessary. In order to make the surface of the magnetic disc smooth, it is desired to further reduce the number of pits (holes) which are likely to occur in a plating layer, to form the surface of the plating layer in such a way as to be smooth.

Large hollows present on the surface of an aluminum alloy substrate are known to be a cause of the occurrence of pits in the plating layer, and it has been found that the large hollows occur when foreign materials present on the substrate surface, such as coarse non-metal inclusions and intermetallic compounds, fall off during grinding or a pre-plating treatment.

Because of the above circumstances, the reduction in the foreign materials present in the aluminum alloy substrate has recently been greatly desired and studied. Japanese Patent Application Publication No. 56-105846 discloses a method of increasing a cooling rate during solidification in casting to micronize an Al—Fe—Mn-based or Mg—Si-based crystallized product (intermetallic compound).

When an aluminum alloy plate is produced, it is general to prepare a melt using aluminum metal as a main raw material. The aluminum metal contains various impurity ingredients. The aluminum metal generally contains about 0.0001 mass % of a chlorine (Cl) ingredient among these. Furthermore, a chromium (Cr) raw material may be loaded in a melt by ingredient adjusting of the melt. In this case, the Cr raw material generally contains about 0.03 mass % of a Cr oxide.

The method disclosed in Japanese Patent Application Publication No. 56-105846 can micronize the Al—Fe—Mn-based or Mg—Si-based crystallized product (intermetallic compound) in a metal matrix. However, there is a problem in which the surface of a magnetic disc cannot be formed in such a way as to be sufficiently smooth even if the crystallized product is micronized when a melt is prepared using the Cl ingredient-containing aluminum metal and the Cr oxide-containing Cr raw material mentioned above. In addition, as production conditions for micronizing the crystallized product, a slab produced in a casting step is required to be a thin slab having a plate thickness of 4 to 15 mm from the viewpoint of providing a rapid-cooling effect, and the production conditions are also restricted.

The present disclosure has been made to solve the problems, and the present disclosure provides an aluminum alloy plate for a magnetic disc substrate which provides excellent plated surface smoothness after plating layer formation and can be produced at low cost, a method for producing an aluminum alloy plate for a magnetic disc substrate, and a magnetic disc prepared using the aluminum alloy plate.

### SUMMARY

In order to solve the problems, the present inventors have focused on Cr oxides and chlorides as the inclusions, and intensively examined and studied the relationship between the distribution state of the inclusions and the smoothness of the plated surface and the relationship between the generation of the inclusions and the production conditions. As a result, the inventors have found that the Cr content and the Cl content, and the amount of a Cr oxide and the Cl content of the raw material greatly affect the generation of the Cr oxide, the smoothness of the ground surface, and the smoothness of the plated surface, and completed the present disclosure.

That is, the aspects of the present disclosure are as follows.

(1) An aluminum alloy plate for a magnetic disc substrate, wherein the aluminum alloy plate comprises, in mass %, Mg: 3.0 to 8.0%, Cu: 0.002 to 0.150%, Zn: 0.05 to 0.60%, Fe: 0.001 to 0.060%, Si: 0.001 to 0.060%, Be: 0.00001 to 0.00200%, Cr: 0.200% or less, Mn: 0.500% or less, and C: 0.00300% or less, with the balance being of Al and inevitable impurities, and

an abundance of a Cr oxide having a maximum diameter of 3 to 10 μm observed in a metal structure is 1 or less per single side of a disc.

(2) The aluminum alloy plate for a magnetic disc substrate according to the above (1), wherein the aluminum alloy plate comprises one or two of Cr: 0.010 to 0.200 mass % and Mn: 0.010 to 0.500 mass %.

(3) The aluminum alloy plate for a magnetic disc substrate according to the above (1), wherein the aluminum alloy plate comprises Be: 0.00001 to 0.00025 mass %.

(4) A method of producing the aluminum alloy plate for a magnetic disc substrate according to the above (1), comprising:

adjusting a melt in such a way as to provide a composition of the aluminum alloy plate as a melt adjusting step;

casting the melt as a casting step;

hot rolling a cast ingot to provide a hot rolled plate as a hot rolling step; and

cold rolling the hot rolled plate to provide a cold rolled plate as a cold rolling step,

wherein the melt adjusting step is a step of loading aluminum metal comprising Cl: 0.00300 mass % or less to adjust the melt.

(5) The method of producing the aluminum alloy plate for a magnetic disc substrate according to the above (4), wherein the melt adjusting step is a step of further loading a Cr raw material containing a Cr oxide: 0.50 mass % or less in the melt to adjust the melt.

(6) A magnetic disc, comprising a plating layer and a magnetic layer on a surface of a circular aluminum alloy substrate prepared using the aluminum alloy plate for a magnetic disc substrate according to the above (1).

According to the present disclosure, it is possible to provide an aluminum alloy plate for a magnetic disc substrate having a composition comprising, in mass %, Mg: 3.0 to 8.0%, Cu: 0.002 to 0.150%, Zn: 0.05 to 0.60%, Fe: 0.001 to 0.060%, Si: 0.001 to 0.060%, Be: 0.00001 to 0.00200%, Cr: 0.200% or less, Mn: 0.500% or less, and Cl: 0.00300% or less, with the balance being of Al and inevitable impurities, wherein an abundance of a Cr oxide having a maximum diameter of 3 to 10 μm observed in a metal structure is 1 or less per single side of a disc, and thereby the aluminum alloy plate for a magnetic disc substrate provides excellent plated surface smoothness after plating layer formation.

According to the present disclosure, the method comprises: a melt adjusting step of adjusting a melt in such a way as to provide the composition of the aluminum alloy plate; a casting step of casting the melt; a hot rolling step of hot rolling the cast ingot to provide a hot rolled plate; and a cold rolling step of cold rolling the hot rolled plate to provide a cold rolled plate, wherein in the melt adjusting step, aluminum metal comprising Cl: 0.00300 mass % or less is loaded to adjust the melt, and thereby the aluminum alloy plate for a magnetic disc substrate having the above characteristics can be produced at low cost.

Furthermore, according to the present disclosure, a plating layer and a magnetic layer are formed on a surface of a circular aluminum alloy substrate prepared using the aluminum alloy plate, and thereby a magnetic disc having a large capacity and a high density can be provided.

### BRIEF DESCRIPTION OF DRAWINGS

FIG. 1 is a flow chart illustrating a series of steps for producing an aluminum alloy plate according to the present disclosure, a series of steps for producing an aluminum alloy substrate using the aluminum alloy plate, and a series of steps for producing a magnetic disc using the aluminum alloy substrate in a connected manner.

### DESCRIPTION OF EMBODIMENTS

Next, a preferred embodiment of the present disclosure will be described.

An aluminum alloy plate for a magnetic disc substrate according to the present disclosure has a composition comprising, in mass %, Mg: 3.0 to 8.0%, Cu: 0.002 to 0.150%, Zn: 0.05 to 0.60%, Fe: 0.001 to 0.060%, Si: 0.001 to 0.060%, Be: 0.00001 to 0.00200%, Cr: 0.200% or less, Mn: 0.500% or less, and C: 0.00300% or less, with the balance being of Al and inevitable impurities, and an abundance of a Cr oxide having a maximum diameter of 3 to 10 μm observed in a metal structure is 1 or less per single side of a disc.

Hereinafter, the reason why the chemical composition of the aluminum alloy plate for a magnetic disc substrate according to the present disclosure and the Cr oxide in the metal structure are limited will be described. All of the units of the content of elements in the chemical composition are represented by “mass %.” Hereinafter, the content is merely expressed in “%” unless otherwise noted.

(I) Chemical Composition

### <Mg: 3.0 to 8.0%>

Mg is an element mainly having the effect of improving the strength of the aluminum alloy plate. Because Mg attaches a zincate film evenly, thinly and finely during zincating, the smoothness of a surface with Ni—P plating is improved in a base treatment step, the step just after a zincating step. However, when the Mg content is less than 3.0 mass %, the strength is insufficient, and furthermore the zincate film generated by zincating becomes uneven, and the adhesiveness and the smoothness of the plating deteriorate. On the other hand, when the Mg content is more than 8.0%, a coarse Al—Mg-based intermetallic compound is generated, and the intermetallic compound falls off during etching, during zincating, or during cutting or grinding and a large hollow occurs, and the smoothness of the plated surface deteriorates. Consequently, the Mg content is set to 3.0 to 8.0%. In view of the balance between the strength and the productivity, it is preferable that the Mg content be 3.5 to 7.0%.

<Cu: 0.002 to 0.150%>

Cu is an element having the effects of reducing the amount of molten Al during zincating and attaching the zincate film evenly, thinly and finely. Because of the effects, the smoothness of the surface with the Ni—P plating is improved in the base treatment step, the step just after the zincating step. However, the above effects cannot be sufficiently obtained when the Cu content is less than 0.002%. On the other hand, when the Cu content is more than 0.150%, a coarse Al—Cu—Mg—Zn-based intermetallic compound is generated, and the intermetallic compound falls off during etching, during zincating, or during cutting or grinding and a large hollow occurs to cause the smoothness of the plated surface to deteriorate. Furthermore, when the Cu content is more than 0.150%, it causes the corrosion resistance of the material itself to deteriorate, and thus the zincate film generated by zincating becomes uneven, and the adhesiveness and smoothness of the plating deteriorate. Consequently, the Cu content is set to 0.002 to 0.150%. It is preferable that the Cu content be 0.002 to 0.100%.

<Zn: 0.05 to 0.60%>

Zn, as does Cu, reduces the amount of molten Al during zincating and attaches the zincate film evenly, thinly and finely. Thus, the smoothness of the surface with the Ni—P plating is improved in the base treatment step, the step just after the zincating step. However, the above effects cannot be sufficiently obtained when the Zn content is less than 0.05%. On the other hand, when the Zn content is more than 0.60%, a coarse Al—Cu—Mg—Zn-based intermetallic compound is generated, and the intermetallic compound falls off during etching, during zincating, or during cutting or grinding and a large hollow occurs to cause the smoothness of the plated surface to deteriorate. Furthermore, when the Zn content is more than 0.60%, it causes the processability and the corrosion resistance of the material itself to deteriorate, and thus the zincate film generated by zincating becomes uneven, and the adhesiveness and the smoothness of the plating deteriorate. Consequently, the Zn content is set to 0.05 to 0.60%, and preferably 0.05 to 0.50%.

<Fe: 0.001 to 0.060%>

Fe hardly becomes solid solution in the aluminum base material but is present in the aluminum metal as an Al—Fe-based intermetallic compound. Because the Al—Fe-based intermetallic compound causes a defect of the ground surface, it is not preferable that Fe be contained in the aluminum alloy. However, reduction of the Fe content to less than 0.001% means to refine the aluminum metal to high purity, resulting in high cost. On the other hand, when the Fe content is more than 0.060%, a coarse Al—Fe-based intermetallic compound is generated, and the coarse Al—Fe-based intermetallic compound falls off during etching, during zincating, or during cutting or grinding and a large hollow occurs, and the smoothness of the plated surface deteriorates. Consequently, the Fe content is set to 0.001 to 0.060% and preferably 0.001 to 0.025%.

<Si: 0.001 to 0.060%>

Si binds to Mg, which is an essential element of the aluminum alloy plate of the present disclosure, to generate an Mg—Si-based intermetallic compound, which causes a defect of the ground surface. Thus, it is not preferable that Si be contained in the aluminum alloy. However, Si is present in the aluminum metal as an inevitable impurity. Aluminum metal having a high purity, for example, a purity of 99.9% or more, is used in a melt adjusting step when an aluminum alloy is produced, and Si is also contained in such a aluminum metal. For this reason, removal of a Si ingredient from the aluminum metal so that the Si content is reduced to less than 0.001% means to refine the aluminum metal to high purity, resulting in high cost. On the other hand, when the Si content is more than 0.060%, a coarse Mg—Si-based intermetallic compound is generated, and the coarse Mg—Si-based intermetallic compound falls off during etching, during zincating, or during cutting or grinding and a large hollow occurs, and the smoothness of the plated surface deteriorates. Consequently, the Si content is set to 0.001 to 0.060%, and preferably 0.001 to 0.025%.

<Be: 0.00001 to 0.00200%>

In general, a small amount of Be is added to the aluminum alloy containing Mg during casting thereof to inhibit the oxidation of the melt by Mg. When the Be content is less than 0.00001%, the corrosion resistance of the material itself deteriorates, and thus the zincate film generated by zincating treatment becomes uneven, and pits occur after plating treatment and the smoothness deteriorates. On the other hand, when the Be content is more than 0.00200%, thick Al—Mg—Be-based oxides are formed during heating after grinding, and thus pits occur during plating treatment and the smoothness of the plated surface deteriorates. Consequently, the Be content is set to 0.00001 to 0.00200%, and preferably 0.00010 to 0.00025%.

<C: 0.00300% or less>

Cl is an element likely to bind to Mg, which is an essential element in the present disclosure, and a part of Cl is present as a Mg—Cl inclusion. A Cl inclusion is dissolved in a plating treatment liquid during plating treatment, and depressed portions are formed in an Al matrix. Many pits occur on the plated surface, and the smoothness of the plated surface deteriorates, and consequently, the Cl content is set to 0.00300% or less. The Cl content of the aluminum alloy substrate is measured by glow discharge mass spectrometry (GDMS). The GDMS measurement can be conducted, for example, using Model VG9000, manufactured by VG ELEMENTAL, as a measuring apparatus under conditions of an accelerating voltage of 8 kV.

The aluminum alloy plate of the present disclosure contains Mg, Cu, Zn, Fe, Si, Be, and Cl as essential ingredients as described above, and can contain Cr: 0.010 to 0.200% and Mn: 0.010 to 0.500% according to the need.

<Cr: 0.010 to 0.200%>

Cr is an element which generates a fine intermetallic compound during casting and which contributes to improvement in strength by becoming partially solid solute in the matrix. Cr also has the effects of improving the cuttability and grindability and remarkably inhibiting the occurrence of plating pits by micronizing the recrystallized structure to improve the adhesiveness of the plating layer. In order to exhibit such the effects, it is preferable to adjust the Cr content to 0.010% or more. However, when the Cr content is more than 0.200%, the excess part is crystallized during casting. At the same time, a coarse Al—Cr-based intermetallic compound is likely to be generated, and the intermetallic compound tends to fall off during etching, during zincating, or during cutting or grinding to create a large hollow, which is a cause of a plating pit. When the Cr content increases, the influence of a Cr oxide contaminated from a Cr raw material cannot be ignored. When the Cr oxide is contained in a large amount in the material, the Cr oxide falls off during etching, during zincating, or during cutting or grinding to generate a large hollow, resulting in causing the smoothness of the plated surface to deteriorate. Consequently, the Cr content is preferably 0.010 to 0.200%, and more preferably 0.010 to 0.100%.

<Mn: 0.010 to 0.500%>

Mn is an element which generates a fine intermetallic compound during casting and which contributes to improvement in strength by becoming partially solid solute in the matrix. Mn also has effects of improving the cuttability and grindability, and still further inhibiting the occurrence of plating pits by micronizing the recrystallized structure to improve the adhesiveness of the plating layer. In order to exhibit such the effects, it is preferable to adjust the Mn content to 0.010% or more. However, when the Mn content is more than 0.500%, the excess part is crystallized during casting. At the same time, a coarse Al—Mn-based intermetallic compound is likely to be generated, and the intermetallic compound tends to fall off during etching, during zincating, or during cutting or grinding to create a large hollow, which is a cause of a plating pit. Consequently, the Mn content is preferably 0.010 to 0.500%, and more preferably 0.010 to 0.100%.

<Balance: Al and Inevitable Impurities>

Components other than the above elements are Al and inevitable impurities. Examples of the “inevitable impurities” here include Ga. The inevitable impurities do not impair the properties of the aluminum alloy plate according to the present disclosure if the content of each element is 0.05% or less and the total content is 0.15% or less.

(II) Abundance of Cr Oxide Observed in Metal (Aluminum Alloy) Structure

In the present disclosure, the abundance of a Cr oxide having a maximum diameter of 3 to 10 μm observed in a metal structure is 1 or less per single side of the disc. Here, the Cr oxide defined in the present disclosure is an inclusion in which it can be confirmed by WDS analysis using an electron probe microanalyzer (EPMA) that the inclusion contains chromium (Cr) and oxygen (O). Also, the maximum diameter in the present disclosure is determined as follows. First, in a planar image of a Cr oxide obtained by wavelength-dispersive X-ray spectrometer (WDS) analysis using an electron probe microanalyzer (EPMA), the largest value of the distances between one point on an outline and the other points on the outline is measured, and then such largest values are measured for all the points on the outline. The maximum diameter is the maximum value finally selected from all of the largest values. Furthermore, for example, the area of the single side of the disc is about 3000 mm² in the case of a 2.5-inch disc, and about 6500 mm² in the case of a 3.5 inch disc.

The abundance of a Cr oxide having a maximum diameter of 3 to 10 μm in the aluminum alloy plate is set to 1 or less per single side of the disc. As a result, a large hollow or a grinding scratch is less likely to occur on the substrate surface during grinding or a pre-plating treatment, and a smooth plated surface can be obtained. When a Cr oxide is present on the substrate surface, a grinding scratch occurs in a wide area from the inclusion as an origination during grinding, and thus the dispersion state of the inclusion can be visually observed. On the other hand, when the maximum diameter of a Cr oxide contained in the aluminum alloy plate is 3 μm to 10 μm, the size of a hollow or a grinding scratch caused due to the inclusion has a slight effect on the occurrence of a plating pit. However, when the abundance of a Cr oxide having a maximum diameter of 3 to 10 μm is 1 or less per single side of the disc, the influence on the occurrence of a pit can be ignored. When the maximum diameter of a Cr oxide contained in the aluminum alloy plate is less than 3 μm, it is not considered that a largeness of hollow or a grinding scratch due to the inclusion is a problem. On the other hand, when at least one Cr oxide having a maximum diameter of more than 10 μm is present on the surface of the disc, a large hollow or a grinding scratch occurs on the substrate surface due to the inclusion, and the smoothness of the plated surface deteriorates. Consequently, the present disclosure is based on the assumption that no Cr oxide having a maximum diameter of more than 10 μm is present on the surface of the disc, i.e., the abundance of the Cr oxide is 0 per single side of the disc. In the present disclosure, the abundance of a Cr oxide having a maximum diameter of 3 to 10 μm is 1 or less per single side of the disc. Optimally, the Cr oxide is not present on the surface of the disc, i.e., the abundance of the Cr oxide is 0 per single side of the disc.

(III) Aluminum Alloy Plate for Magnetic Disc Substrate According to the Present Disclosure, and Method for Producing Magnetic Disc

Sequentially, preferred embodiments of an aluminum alloy plate for a magnetic disc substrate and a method for producing a magnetic disc according to the present disclosure will be described below.

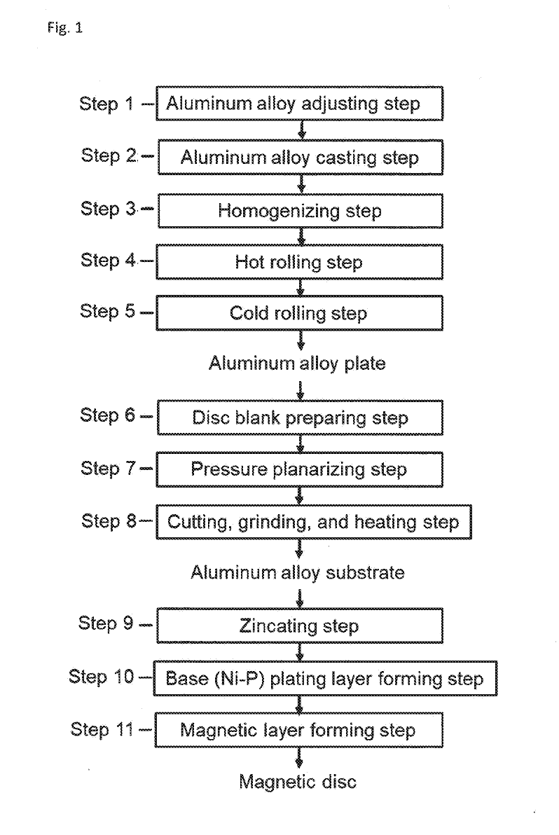

First, a series of steps between the producing step of the aluminum alloy plate and the producing step of the magnetic disc will be described with reference to a typical producing flow shown in FIG. 1. Here, steps 1 to 5 are a series of steps for producing the aluminum alloy plate, and steps 6 to 11 are a series of steps for producing a magnetic disc using the produced aluminum alloy plate.

1. Producing Flow Between Producing Step of Aluminum Alloy Plate and Producing Step of Magnetic Disc

(1) Step 1: A melt is adjusted so that aluminum alloy with a desired composition (for example, prepared with a composition shown in Table 1 below) is obtained in a melting furnace and transferred to a holding furnace. Furthermore, the melt is held in the holding furnace at a predetermined temperature for a predetermined period.

(2) Step 2: The blended melt of aluminum alloy is cast.

(3) Step 3: The surfaces of the cast ingot are shaved off, and the ingot is homogenized (the homogenizing step is not essential in the present disclosure, and appropriately conducted).

(4) Step 4: The surface-shaved or homogenized ingot is hot rolled to a hot rolled plate.

(5) Step 5: The hot rolled plate is cold rolled to produce an aluminum alloy plate as a cold rolled plate. Annealing is conducted before or during cold rolling (annealing is not essential in the present disclosure, and appropriately conducted).

(6) Step 6: A circular shape is punched out of the aluminum alloy plate to prepare a disc blank.

(7) Step 7: The disc blank is flattened by pressure annealing.

(8) Step 8: The flattened disc blank is subjected to cut, ground, and heated treatments, to obtain an aluminum alloy substrate for magnetic disc.

(9) Step 9: A surface of the aluminum alloy substrate for magnetic disc is degreased, etched, and zincated (Zn substitution treatment).

(10) Step 10: The zincated surface of the aluminum alloy substrate is subjected to a base treatment to form a plating layer (for example, a Ni—P plating layer) on the surface.

(11) Step 11: A magnetic material (magnetic layer) is attached to the surface of the plating layer formed by the base treatment by sputtering, to produce a magnetic disc.

2. Method for Producing Aluminum Alloy Plate for Magnetic Disc Substrate According to the Present Disclosure

The aluminum alloy plate for a magnetic disc substrate according to the present disclosure is produced by the steps 1 to 5. That is, in the melt adjusting step (step 1), the melt of aluminum alloy which has been adjusted to fall in the composition of the aluminum alloy plate of the present disclosure is heated and held in a holding furnace so that the melt does not become cold and hard before casting. Then, the melt is cast according to a general method such as a Direct Chill Casting (DC casting) method in the casting step (step 2). The obtained ingot is homogenized (step 3) according to the need, and the cast ingot is then hot rolled to a hot rolled plate in the hot rolling step (step 4). Next, the hot rolled plate is cold rolled to produce an aluminum alloy plate as a cold rolled plate in the cold rolling step (step 5). Hereinafter, each of the steps will be described in detail.

(1) Step 1 (Melt Adjusting Step)

In the melt adjusting step (step 1), the melt of aluminum alloy which has been adjusted to fall in the composition of the aluminum alloy plate to be produced is heated and held in a holding furnace so that the melt does not become cold and hard before casting. After the melt is held in the holding furnace, it is preferable to conduct the degassing treatment and the filtration treatment inline according to general methods before casting the alloy. As the inline degassing apparatus, commercially available apparatuses with trade names such as SNIF and ALPUR may be used. In these apparatuses, while argon gas or the like is blown into the melt, a rotor with a blade is rotated with high speed to supply the gas as fine bubbles to the melt. As a result, the removal of hydrogen gas and the removal of the inclusions can be conducted inline in a short time. For the inline filtration, a ceramic tube filter, a ceramic foam filter, or an alumina ball filter or the like is used, and the inclusions can be removed to some extent by a cake filtration mechanism or a filter medium filtration mechanism.

In the method for producing the aluminum alloy plate of the present disclosure, particularly, in the melt adjusting step, aluminum metal having a chlorine (Cl) content regulated to 0.00300 mass % or less is loaded as aluminum metal which is a main raw material, and when a Cr ingredient is adjusted, a Cr raw material having a Cr oxide content regulated to 0.50 mass % or less is loaded as a Cr raw material to adjust a melt.

When the present inventors have examined the distribution state of Cr oxides in an aluminum alloy structure, the present inventors have found the following: Any step has an effect on the distribution state of the Cr oxides in no small measure, but in particular, conditions in the melt adjusting step in the step 1 have a large effect on the distribution state of the Cr oxides. Specifically, aluminum metal regulated to Cl: 0.00300 mass % or less is used as an aluminum metal which is a main raw material for preparing a melt, and additionally the melt is adjusted using a Cr raw material having an amount of Cr oxides regulated to 0.50 mass % or less as the Cr raw material when the Cr raw material is loaded into the melt in order to adjust a Cr ingredient. Thereby, the aluminum alloy plate having the above described chemical composition and the abundance of the Cr oxides observed in the metal structure can be produced. Thus the present disclosure has been completed. Hereinafter, the reason why the raw materials are limited will be described.

The Cl content of the aluminum metal is set to 0.00300 mass % or less in the stage of adjusting the melt for aluminum alloy. If the Cl content of the aluminum metal is more than 0.00300 mass %, the Cl content is more than 0.00300 mass % and the Cl inclusions are formed in the metal structure when the aluminum alloy substrate for magnetic disc is produced, and thereby pits occur during the plating treatment, and the smoothness of the plated surface deteriorates. Consequently, the Cl content of the aluminum metal is set to 0.00300 mass % or less, and preferably 0.00200% or less. Reduction of the Cl content of the aluminum metal to less than 0.00001 mass % causes high cost of production, and thus the lower limit of the Cl content of the aluminum metal is about 0.00001%.

In the stage of adjusting the melt of aluminum alloy, the use of a Cr raw material having an amount of Cr oxides regulated to 0.50 mass % or less can reduce an amount of Cr oxides in the material. If the amount of Cr oxides is more than 0.50 mass %, a large amount of coarse Cr oxides is present in the material, and pits occurs during plating treatment and the smoothness of the plated surface deteriorates. Consequently, the amount of Cr oxides in the Cr raw material is set to 0.50 mass % or less, and preferably 0.10 mass % or less. The Cr oxides are mixed as impurities in the production of the Cr raw material. Cr is generally obtained by reducing the Cr oxides with Al or the like. However, it is difficult to reduce all the Cr oxides to Cr, and thus a part of the Cr oxides remain, and are contained in the Cr raw material. Removal of the Cr oxides from the Cr raw material so that the amount of the Cr oxides is less than 0.0001 mass % causes high cost of production, and thus the lower limit of the amount of Cr oxides in the Cr raw material is about 0.0001%.

The quantitative determination method of the amount of Cr oxides is as follows. First, 2 g of a raw material is added into a solution obtained by mixing hydrochloric acid and water at a rate of 1:1, and Cr is dissolved in the solution. Subsequently, the solution is filtered with a filter. After the filtration, the filter is placed in a crucible, and exposed to a burner, to incinerate the filter. A mixture containing 0.5 g of sodium carbonate and 0.15 g of boric acid is added into the crucible, and exposed to a burner. The crucible is placed in an electric furnace, heated, and naturally cooled. Warmed ultrapure water and hydrochloric acid (1:1) are added into the crucible, followed by heating. The volume of the solution in the crucible is measured by using a measuring flask, and the amount of Cr is measured by ICP, to calculate an amount of Cr oxides.

(2) Step 2 (Casting Step)

The blended melt of aluminum alloy is held in the holding furnace, and then cast.

(3) Step 3 (Homogenizing Step)

Subsequently, the surfaces of the cast ingot are shaved off, and the ingot is then subjected to homogenizing treatment according to the need. It is preferable to conduct the homogenizing treatment preferably under conditions of 480 to 560° C. and 1 hour or more, and more preferably under conditions of 500 to 550° C. and 2 hours or more when the homogenizing treatment is performed. This is because, when the treatment temperature is lower than 480° C., or when the treatment time is less than 1 hour, in some cases a satisfactory homogenizing effect cannot be obtained. This is because, when the treatment temperature is higher than 560° C., there is a possibility that the material is dissolved.

(4) Step 4 (Hot Rolling Step)

Subsequently, the ingot having the shaved-off surfaces or homogenized is hot rolled to a hot rolled plate. Here, the plate thickness of the hot rolled plate may be, for example, about 3.0 mm. When the hot rolling is conducted, the conditions for the hot rolling is not particularly limited, and it is preferable that the hot rolling start temperature be 300 to 500° C., and it is more preferable that the hot rolling start temperature be 320 to 480° C. It is preferable that the hot rolling termination temperature be 260 to 400° C., and it is more preferable that the hot rolling termination temperature be 280 to 380° C. When the hot rolling start temperature is lower than 300° C., the hot rolling processability cannot be secured, and, when the hot rolling start temperature is higher than 500° C., in some cases the crystal grains become coarse and the plating adhesion deteriorates. When the hot rolling termination temperature is lower than 260° C., the hot rolling processability cannot be secured, and when the hot rolling termination temperature is higher than 400° C., in some cases the crystal grains become coarse and the plating adhesion deteriorates. In hot rolling, generally, the ingot is heated and held at the hot rolling start time for 0.5 to 10.0 hours, and then hot rolled. When a homogenizing treatment is conducted, the heating and holding of the ingot may be replaced by the homogenizing treatment.

(5) Step 5 (Cold Rolling Step)

Subsequently, the hot rolled plate is cold rolled to produce an aluminum alloy plate as a cold rolled plate. Annealing is conducted before or during cold rolling. The plate thickness of the aluminum alloy plate (cold rolled plate) is preferably 0.4 to 2.0 mm, and more preferably 0.6 to 2.0 mm. That is, after completion of the hot rolling, the plate is finished by cold rolling in such a way as to have a required product thickness. The conditions for the cold rolling are not particularly limited, and may be determined according to the required product plate strength or plate thickness, and it is preferable that the reduction ratio by rolling be 20 to 90%, and it is more preferable that the reduction ratio by rolling be 20 to 80%. When the reduction ratio by rolling is less than 20%, in some cases the crystal grains become coarse in the pressure flattening annealing and the plating adhesion deteriorates, and when the reduction ratio by rolling is more than 90%, in some cases the production time is prolonged to cause the productivity to deteriorate.

In order to secure good processability in the cold rolling, an annealing treatment may be conducted before the cold rolling or during the cold rolling. When an annealing treatment is conducted, it is preferable to conduct for example, batch-type annealing under conditions of 300 to 430° C. and 0.1 to 10 hours, and it is more preferable to conduct batch-type annealing under conditions of 300 to 380° C. and 1 to 5 hours. When the annealing temperature is lower than 300° C., or when the annealing time is less than 0.1 hours, sometimes a satisfactory annealing effect cannot be obtained. When the annealing temperature is higher than 430° C., in some cases the crystal grains become coarse and the plating adhesion deteriorates, and when the annealing time is more than 10 hours, it causes the productivity to deteriorate. On the other hand, it is preferable to conduct continuous annealing under holding conditions of 400 to 500° C. and 0 to 60 seconds, and it is more preferable to conduct continuous annealing under holding conditions of 450 to 500° C. and 0 to 30 seconds. When the annealing temperature is lower than 400° C., sometimes a satisfactory annealing effect cannot be obtained. When the annealing temperature is higher than 500° C., in some cases the crystal grains become coarse and the plating adhesion deteriorates, and when the annealing time is more than 60 seconds, in some cases the crystal grains become coarse and the plating adhesion deteriorates. The holding time “0 seconds” in the annealing means that cooling is started immediately after the temperature has reached a desired annealing temperature.

3. Method for Producing Magnetic Disc of the Present Disclosure

A magnetic disc of the present disclosure is produced by the above-described steps 6 to 11 using the aluminum alloy plate produced in the above-described steps 1 to 5. That is, a circular shape is punched out of the aluminum alloy plate to prepare a disc blank (step 6), and the disc blank is flattened by pressure annealing (step 7). The flattened disc blank is cut, ground, and heated, to obtain an aluminum alloy substrate for magnetic disc (step 8). A surface of the aluminum alloy substrate is degreased, etched, and zincated (Zn substitution treatment) (step 9). The zincated surface of the aluminum alloy substrate is subjected to a base treatment to form a plating layer (for example, a Ni—P plating layer) on the surface (step 10). A magnetic material (magnetic layer) is formed and attached to the surface of the plating layer formed by the base treatment by sputtering (step 11), to produce a magnetic disc. Hereinafter, each of the steps will be described in detail.

(1) Step 6 (Disc Blank Preparing Step)

A circular shape is punched out of the aluminum alloy plate produced by the above-described steps 1 to 5 to prepare a disc blank.

(2) Step 7 (Pressure Planarizing Step)

Subsequently, the plurality of punched-out circular aluminum alloy plates are piled. The pile is subjected to pressure annealing where the pile is annealed under conditions of 250 to 430° C. in the atmosphere for 30 minutes or more while pressure is applied to the pile from top and bottom, to flatten the pile. When the treatment temperature is lower than 250° C., or when the treatment time is less than 30 minutes, in some cases a flattening effect cannot be obtained. When the treatment temperature is higher than 430° C., in some cases the crystal grains become coarse and the plating adhesion deteriorates. It is preferable to conduct the pressurization under a pressure of 1.0 to 3.0 MPa.

(3) Step 8 (Cutting, Grinding, and Heating Step)

The flattened disc blank is cut, ground, and heated to obtain an aluminum alloy substrate for magnetic disc. After the grinding, the disc blank may be heated for straightening the disc blank. It is preferable to conduct the heating treatment under conditions of 200 to 400° C. and 5 to 15 minutes, and it is more preferable to conduct the heating treatment under conditions of 200 to 300° C. and 5 to 10 minutes. When the heating temperature is lower than 200° C., or when the heating time is less than 5 minutes, sometimes a satisfactory straightening effect cannot be obtained. When the heating temperature is higher than 400° C., or when the heating time is more than 15 minutes, the Al—Mg—Be-based oxide in the surface layer of the aluminum alloy substrate becomes thick, and thus the Al—Mg—Be-based oxide tends to remain without being completely removed in the pre-plating treatment, which causes many pits to occur.

(4) Step 9 (Zincating Step)

The surface of the aluminum alloy substrate is sequentially degreased, etched, and zincated (Zn substitution treatment).

It is preferable to conduct the degreasing for example using a commercially available AD-68F (manufactured by UYEMURA & Co., Ltd.) degreaser or the like under conditions of a temperature of 40 to 70° C., a treatment time of 3 to 10 minutes, and a concentration of 200 to 800 mL/L, and it is more preferable to conduct the degreasing under conditions of a temperature of 45 to 65° C., a treatment time of 4 to 8 minutes, and a concentration of 300 to 700 mL/L. When the temperature is lower than 40° C. or when the treatment time is less than 3 minutes, or when the concentration is less than 200 mL/L, sometimes a satisfactory degreasing effect cannot be obtained. Additionally, when the temperature is higher than 70° C. or when the treatment time is more than 10 minutes, or when the concentration is more than 800 mL/L, sometimes the smoothness of the substrate surface deteriorates, pits occur after the plating treatment, and the smoothness deteriorates.

It is preferable to conduct the etching for example using a commercially available AD-107F (manufactured by UYEMURA & Co., Ltd.) etching liquid or the like under conditions of a temperature of 50 to 75° C., a treatment time of 0.5 to 5 minutes, and a concentration of 20 to 100 mL/L, and it is more preferable to conduct the etching under conditions of a temperature of 55 to 70° C., a treatment time of 0.5 to 3 minutes, and a concentration of 40 to 100 ml/L. When the temperature is lower than 50° C. or when the treatment time is less than 0.5 minute, or when the concentration is less than 20 mL/L, sometimes a satisfactory etching effect cannot be obtained. Additionally, when the temperature is higher than 75° C. or when the treatment time is more than 5 minutes, or when the concentration is more than 100 mL/L, sometimes the smoothness of the substrate surface deteriorates, pits occur after the plating treatment, and the smoothness deteriorates. A general desmutting treatment may be conducted between the etching treatment and the below-mentioned zincate treatment.

It is preferable to conduct the zincate treatment, for example, using a commercially available AD-301F-3X (manufactured by UYEMURA & Co., Ltd.) zincate treatment liquid or the like under conditions of a temperature of 10 to 35° C., a treatment time of 0.1 to 5 minutes, and a concentration of 100 to 500 mL/L, and it is more preferable to conduct the zincate treatment under conditions of a temperature of 15 to 30° C., a treatment time of 0.1 to 2 minutes, and a concentration of 200 to 400 mL/L. When the temperature is lower than 10° C. or when the treatment time is less than 0.1 minute, or when the concentration is less than 100 mL/L, sometimes the zincate film becomes non-uniform, conventional pits occur after the plating treatment, and the smoothness deteriorates. Additionally, when the temperature is higher than 35° C. or when the treatment time is more than 5 minutes, or when the concentration is more than 500 mL/L, sometimes the zincate film becomes non-uniform, conventional pits occur after the plating treatment, and the smoothness deteriorates.

(5) Step 10 (Plating Layer Forming Step)

Subsequently, the surface of the zincated aluminum alloy substrate is subjected to electroless plating as a base treatment, to form a plating layer (for example, Ni—P alloy plating layer) on the surface. Furthermore, the surface of the plating layer is polished. It is preferable to conduct the electroless Ni—P alloy plating treatment, for example, using a commercially available Nimuden HDX (manufactured by UYEMURA & Co., Ltd.) plating solution or the like under conditions of a temperature of 80 to 95° C., a treatment time of 30 to 180 minutes, and a Ni concentration of 3 to 10 g/L, and it is more preferable to conduct the electroless Ni—P alloy plating treatment under conditions of a temperature of 85 to 95° C., a treatment time of 60 to 120 minutes, and a Ni concentration of 4 to 9 g/L. When the temperature is lower than 80° C., or when the Ni concentration is less than 3 g/L, in some cases the growth rate of plating is slow to cause the productivity to decrease. When the treatment time is less than 30 minutes, sometimes many defects occur on the plated surface and the smoothness of the plated surface deteriorates. When the temperature is higher than 95° C., or when the Ni concentration is more than 10 g/L, in some cases plating non-uniformly grows to cause the smoothness of the plating to deteriorate. When the treatment time is more than 180 minutes, sometimes it causes the productivity to reduce. The aluminum alloy substrate subjected to the base treatment of the present disclosure is obtained by the pre-plating treatment and the Ni—P alloy plating treatment.

(6) Step 11 (Magnetic Layer Forming Step)

Finally, a magnetic material (magnetic layer) is formed and attached to the surface of the plating layer of the aluminum alloy substrate subjected to the base treatment by sputtering, to produce a magnetic disc.

Embodiments of the present disclosure described above are merely illustrative, and various changes may be made in the scope of claims.

### EXAMPLES

Hereinafter, Examples of the present disclosure will be described. First, as shown in Table 1, aluminum metals each having a Cl content and Cr raw materials each having an amount of Cr oxides (except for alloys of Example Nos. 4 and 5) were used, and melts of aluminum alloy each having a composition shown in Table 1 were meltingly produced. Subsequently, ingots each having a thickness of 500 mm were produced from the melts of aluminum alloy by a DC casting method, and both surfaces of each ingot were shaved off by 15 mm. Subsequently, the alloys (except for the alloy of Example No. 6) were homogenized at 510° C. for 6 hours. Hot rolling was then conducted at a rolling start temperature of 460° C. and a rolling termination temperature of 340° C., and hot rolled plates each having a plate thickness of 3.0 mm were obtained. Then, the hot rolled plates, except for the alloy of Example No. 7, were cold rolled (reduction ratio by rolling of 66.7%) to a final plate thickness of 1.0 mm without conducting intermediate annealing, and cold rolled plates (aluminum alloy plates) were thus obtained. As for the hot rolled plate of Example No. 7, first, after first cold rolling (reduction ratio by rolling of 33.3%), intermediate annealing was conducted under the conditions of 300° C. and 2 hours using a batch-style annealing furnace. Next, the alloy was rolled by second cold rolling (reduction ratio by rolling of 50.0%) to a final plate thickness of 1.0 mm, and a cold rolled plate (aluminum alloy plate) was thus obtained. Subsequently, a circular shape with an outer diameter of 96 mm and an inner diameter of 24 mm was punched out of each of the aluminum alloy plates, and disc blanks were thus produced. The disc blanks were then pressure annealed at 340° C. for 4 hours. End-face machining of the disc blanks was then conducted to reduce the outer diameters to 95 mm and the inner diameters to 25 mm, and grinding of the disc blanks was conducted (the surfaces of 10 μm in depth were ground off). Heating of the disc blanks was conducted at 300° C. for 10 minutes. Subsequently, degreasing of the disc blanks was conducted by AD-68F (manufactured by C. Uyemura & Co., Ltd.) at 60° C. for 5 minutes, and etching of the disc blanks was then conducted by AD-107F (manufactured by C. Uyemura & Co., Ltd.) at 65° C. for 1 minute. Furthermore, the disc blanks were desmutted with an aqueous 30% HNO₃ solution (room temperature) for 20 seconds. Then, the surfaces of the surface-treated disc blanks were subjected to double zincating using AD-301F-3X (manufactured by C. Uyemura & Co., Ltd.). Furthermore, a Ni—P alloy plating layer was formed with a thickness of 19 μm on the zincated surfaces of the disc blanks using an electroless Ni—P alloy plating solution (Nimuden HDX (manufactured by C. Uyemura & Co., Ltd.)), and then finished by final polishing with a buffing pad (buff) (polishing amount of 5 μm) to obtain a magnetic disc. In the compositions of Table 1, the sign of “-” expresses a detection limit or less.

TABLE 1

| | | Composition (mass %) | | | | | | | | | | | |
|---|---|---|---|---|---|---|---|---|---|---|---|---|---|
| | | | | | | | | | | | Aluminum + | Amount of Cr | Cl content of |
| | Alloy | | | | | | | | | | inevitable | oxides in Cr raw | aluminum metal |
| | No. | Mg | Cu | Zn | Fe | Si | Be | Cr | Mn | Cl | impurities | material (mass %) | (mass %) |
| Examples | 1 | 4.3 | 0.148 | 0.05 | 0.020 | 0.023 | 0.00001 | 0.010 | 0.490 | 0.00001 | Balance | 0.01 | 0.00001 |
| | 2 | 7.9 | 0.088 | 0.47 | 0.023 | 0.015 | 0.00010 | 0.090 | 0.070 | 0.00010 | Balance | 0.50 | 0.00013 |
| | 3 | 3.0 | 0.002 | 0.59 | 0.001 | 0.059 | 0.00020 | 0.070 | 0.100 | 0.00100 | Balance | 0.03 | 0.00106 |
| | 4 | 4.5 | 0.046 | 0.11 | 0.059 | 0.001 | 0.00010 | — | 0.070 | 0.00280 | Balance | — | 0.00296 |
| | 5 | 5.4 | 0.028 | 0.19 | 0.018 | 0.029 | 0.00030 | — | 0.010 | 0.00010 | Balance | — | 0.00013 |
| | 6 | 6.8 | 0.034 | 0.33 | 0.018 | 0.018 | 0.00200 | 0.100 | — | 0.00010 | Balance | 0.15 | 0.00013 |
| | 7 | 7.9 | 0.028 | 0.39 | 0.001 | 0.016 | 0.00150 | 0.190 | 0.030 | 0.00010 | Balance | 0.03 | 0.00013 |
| Comparative | 8 | 8.3 | 0.084 | 0.39 | 0.017 | 0.025 | 0.00150 | 0.080 | 0.030 | 0.00010 | Balance | 0.03 | 0.00013 |
| Examples | 9 | 5.0 | 0.167 | 0.25 | 0.011 | 0.019 | 0.00030 | 0.150 | 0.030 | 0.00010 | Balance | 0.03 | 0.00013 |
| | 10 | 4.4 | 0.082 | 0.68 | 0.025 | 0.012 | 0.00030 | 0.080 | 0.030 | 0.00010 | Balance | 0.03 | 0.00013 |
| | 11 | 3.9 | 0.008 | 0.25 | 0.067 | 0.017 | 0.00030 | 0.340 | 0.030 | 0.00010 | Balance | 0.03 | 0.00012 |
| | 12 | 3.6 | 0.079 | 0.34 | 0.035 | 0.072 | 0.00030 | 0.030 | 0.030 | 0.00010 | Balance | 0.03 | 0.00012 |
| | 13 | 3.8 | 0.011 | 0.30 | 0.011 | 0.035 | 0.00250 | 0.100 | 0.030 | 0.00010 | Balance | 0.03 | 0.00012 |
| | 14 | 4.7 | 0.032 | 0.44 | 0.020 | 0.025 | 0.00030 | 0.250 | 0.030 | 0.00010 | Balance | 0.03 | 0.00013 |
| | 15 | 4.5 | 0.084 | 0.46 | 0.021 | 0.010 | 0.00030 | 0.120 | 0.650 | 0.00010 | Balance | 0.03 | 0.00013 |
| | 16 | 5.4 | 0.023 | 0.19 | 0.023 | 0.015 | 0.00030 | 0.110 | 0.030 | 0.00350 | Balance | 0.03 | 0.00374 |
| | 17 | 2.7 | 0.023 | 0.47 | 0.023 | 0.023 | 0.00030 | 0.070 | 0.030 | 0.00010 | Balance | 0.03 | 0.00012 |
| | 18 | 5.0 | 0.001 | 0.16 | 0.012 | 0.014 | 0.00030 | 0.140 | 0.030 | 0.00010 | Balance | 0.03 | 0.00013 |
| | 19 | 4.0 | 0.091 | 0.03 | 0.021 | 0.019 | 0.00030 | 0.010 | — | 0.00010 | Balance | 0.03 | 0.00012 |
| | 20 | 4.4 | 0.037 | 0.20 | 0.022 | 0.014 | — | 0.130 | — | 0.00010 | Balance | 0.03 | 0.00013 |
| | 21 | 3.9 | 0.060 | 0.49 | 0.013 | 0.017 | 0.00030 | 0.130 | — | 0.00010 | Balance | 0.61 | 0.00012 |
| | 22 | 5.0 | 0.079 | 0.40 | 0.012 | 0.019 | 0.00030 | 0.130 | — | 0.00010 | Balance | 0.93 | 0.00013 |

An aluminum alloy substrate (S1) after the step 8 (cutting, grinding and heating) and an aluminum alloy substrate (S2) having the plating layer after the step 10 (forming step of Ni—P alloy plating layer) were subjected to the following evaluations.

[Abundance of Cr Oxide]

The abundance (the number per single side of the disc) of the Cr oxides having a maximum diameter of 3 to 10 μm was determined by: visually examining the surface of an aluminum alloy plate (S1) after grinding and heating; counting the number of the Cr oxides having a maximum diameter of 3 to 10 μm per single side of each disc while identifying the Cr oxides through an EPMA observation image and WDS analysis (wavelength dispersive X-ray analysis); and converting the number to abundance. When Cr oxides are present on the substrate surface, a grinding scratch occurs in a wide area from the inclusion during grinding. Thus, the dispersion state of the inclusion can be visually observed. The abundance is shown in Table 2.

[Plated Surface Smoothness]

The surface of an aluminum alloy plate (S2) after the forming step of the Ni—P alloy plating layer was observed using a device such as an optical surface analyzer (OSA). The number of pits having a maximum diameter of 0.5 m or more per single side of the disc was counted, and the number per unit area (number density: the number per single side of the disc) was determined. The evaluation criteria were as follows: the case where the number of pits per single side of the disc was 10 or less was defined as excellent and marked with “A”; the case where the number of pits was more than 10 and 30 or less was defined as good and marked with “B”; and the case where the number of pits was more than 30 was defined as poor and marked with “C”. Evaluation results are shown in Table 2.

TABLE 2

| | | Aluminum alloy | Aluminum alloy substrate having | |
|---|---|---|---|---|
| | | substrate (S1) | plating layer (S2) | |
| | | Abundance of Cr | Smoothness of plated surface | |
| | | oxides having | Abundance of plating | |
| | | maximum diameter | pits having maximum | |
| | | of 3 to 10 mm | diameter of 0.5 mm or | |
| | Alloy | (number per single | more (number per | Evalu- |
| | No. | side of disc) | single side of disc) | ation |
| Exam- | 1 | 0 | 0 | A |
| ples | 2 | 1 | 28 | B |
| | 3 | 0 | 2 | A |
| | 4 | 0 | 8 | A |
| | 5 | 0 | 12 | B |
| | 6 | 0 | 15 | B |
| | 7 | 0 | 18 | B |
| Compa- | 8 | 0 | 130 | C |
| ative | 9 | 0 | 82 | C |
| Exam- | 10 | 0 | 72 | C |
| ples | 11 | 0 | 212 | C |
| | 12 | 0 | 125 | C |
| | 13 | 0 | 81 | C |
| | 14 | 0 | 182 | C |
| | 15 | 0 | 210 | C |
| | 16 | 0 | 241 | C |
| | 17 | 0 | 52 | C |
| | 18 | 0 | 35 | C |
| | 19 | 0 | 51 | C |
| | 20 | 0 | 38 | C |
| | 21 | 3 | 108 | C |
| | 22 | 7 | 56 | C |

From the evaluation results shown in Table 2, in all of Example alloys Nos. 1 to 7, aluminum alloy substrates for a magnetic disc substrate in which the abundance of a Cr oxide having a maximum diameter of 3 to 10 μm was 1 or less per single side of the disc, and the plated surface smoothness was excellent or good were obtained.

In contrast, in all of Comparative Example alloys Nos. 8 to 22, any one of the chemical composition and the abundance of the Cr oxide falls outside the scope of the present disclosure, and thus the smoothness of the plated surface is poor.

That is, in Comparative Example alloy No. 8, because the Mg content was too higher than the appropriate scope of the present disclosure, a coarse Al—Mg-based intermetallic compound was generated in a large amount, and the intermetallic compound fell off during the pre-plating treatment and large hollows occurred on the aluminum alloy plate surface. As a result, many pits occurred on the plated surface, and the smoothness of the plated surface was poor.

In Comparative Example alloy No. 9, because the Cu content was too higher than the appropriate scope of the present disclosure a coarse Al—Cu—Mg—Zn-based intermetallic compound was generated in a large amount, and the intermetallic compound fell off during the pre-plating treatment and large hollows occurred on the aluminum alloy plate surface. As a result, many pits occurred on the plated surface, and the smoothness of the plated surface was poor.

In Comparative Example alloy No. 10, because the Zn content was too higher than the appropriate scope of the present disclosure, a coarse Al—Cu—Mg—Zn-based intermetallic compound was generated in a large amount, and the intermetallic compound fell off during the pre-plating treatment and large hollows occurred on the aluminum alloy plate surface. As a result, many pits occurred on the plated surface, and the smoothness of the plated surface were poor.

In Comparative Example alloy No. 11, because the Fe content was too higher than the appropriate scope of the present disclosure, a coarse Al—Fe-based intermetallic compound was generated in a large amount, and the intermetallic compound fell off during the pre-plating treatment and large hollows occurred on the aluminum alloy plate surface. As a result, many pits occurred on the plated surface, and the smoothness of the plated surface was poor.

In Comparative Example alloy No. 12, because the Si content was too higher than the appropriate scope of the present disclosure, a coarse Mg—Si-based intermetallic compound was generated in a large amount, and the intermetallic compound fell off during the pre-plating treatment and large hollows occurred on the aluminum alloy plate surface. As a result, many pits occurred on the plated surface, and the smoothness of the plated surface was poor.

In Comparative Example alloy No. 13, because the Be content was too higher than the appropriate scope of the present disclosure, thick Al—Mg—Be-based oxides were formed by heating after grinding. As a result, many fine pits occurred on the plated surface, and the smoothness of the plated surface was poor.

In Comparative Example alloy No. 14, because the Cr content was too higher than the appropriate scope of the present disclosure, a coarse Al—Cr-based intermetallic compound was generated in a large amount, and the intermetallic compound fell off during the pre-plating treatment and large hollows occurred on the aluminum alloy plate surface. As a result, many pits occurred on the plated surface, and the smoothness of the plated surface was poor.

In Comparative Example alloy No. 15, because the Mn content was too higher than the appropriate scope of the present disclosure, a coarse Al—Mn-based intermetallic compound was generated in a large amount, and the intermetallic compound fell off during the pre-plating treatment and large hollows occurred on the aluminum alloy plate surface. As a result, many pits occurred on the plated surface, and the smoothness of the plated surface was poor.

In Comparative Example alloy No. 16, because the Cl content was too higher than the appropriate scope of the present disclosure, a Mg—Cl-based compound was generated in a large amount. As a result, many fine pits occurred on the plated surface, and the smoothness of the plated surface was poor. Because the Mg content was too low, the zincate film was uneven. As a result, many pits occurred on the plated surface, and the smoothness of the plated surface was poor.

In Comparative Example alloy No. 17, because the Mg content was too lower than the appropriate scope of the present disclosure, the zincate film was uneven. As a result, many pits occurred on the plated surface, and the smoothness of the plated surface was poor.

In Comparative Example alloy No. 18, because the Cu content was too lower than the appropriate scope of the present disclosure, the zincate film was uneven. As a result, many pits occurred on the plated surface, and the smoothness of the plated surface was poor.

In Comparative Example alloy No. 19, because the Zn content was too lower than the appropriate scope of the present disclosure, the zincate film was uneven. As a result, many pits occurred on the plated surface, and the smoothness of the plated surface was poor.

Because Comparative Example alloy No. 20 did not contain Be, the zincate film was uneven. As a result, many pits occurred on the plated surface, and the smoothness of the plated surface was poor.

In Comparative Example alloy No. 21, because the abundance of Cr oxides having a maximum diameter of 3 to 10 μm observed in a metal structure was as high as 3 per single side of the disc, many large hollows or grinding scratches due to the inclusions (Cr oxides) occurred on the substrate surface, and the smoothness of the plated surface was poor.

In Comparative Example alloy No. 22, because the abundance of Cr oxides having a maximum diameter of 3 to 10 μm observed in a metal structure was as high as 7 per single side of the disc, many large hollows or grinding scratches due to the inclusions (Cr oxides) occurred on the substrate surface, and the smoothness of the plated surface was poor.

As described above, in the aluminum alloy plate for a magnetic disc substrate according to the present disclosure, the number of Cr oxides having a maximum diameter of 3 m or more is controlled before conducting a treatment such as grinding, the pre-plating treatment, or the like. Thus, the aluminum alloy plate has an inhibitory effect on the occurrence of a hollow and a grinding scratch, and excellent plated surface smoothness can be obtained. By using such an aluminum alloy plate, a magnetic disc having a large capacity and a high density can be obtained.

What is claimed is:

1. An aluminum alloy plate for a magnetic disc substrate, wherein the aluminum alloy plate comprises, in mass %, Mg: 3.0 to 8.0%, Cu: 0.002 to 0.150%, Zn: 0.05 to 0.60%, Fe: 0.001 to 0.060%, Si: 0.001 to 0.060%, Be: 0.00001 to 0.00200%, Cr: 0.200% or less, Mn: 0.500% or less, and Cl: 0.00300% or less, with the balance being Al and inevitable impurities, and
an abundance of a Cr oxide having a maximum diameter of 3 to 10 μm observed in a metal structure is 1 or less per single side of a disc.

2. The aluminum alloy plate for a magnetic disc substrate according to claim 1, wherein the aluminum alloy plate comprises one or two of Cr: 0.010 to 0.200 mass % and Mn: 0.010 to 0.500 mass %.

3. The aluminum alloy plate for a magnetic disc substrate according to claim 1, wherein the aluminum alloy plate comprises Be: 0.00001 to 0.00025 mass %.

4. A method of producing the aluminum alloy plate for a magnetic disc substrate according to claim 1, comprising:
adjusting a melt in such a way as to provide a composition of the aluminum alloy plate as a melt adjusting step;
casting the melt as a casting step;
hot rolling a cast ingot to provide a hot rolled plate as a hot rolling step; and
cold rolling the hot rolled plate to provide a cold rolled plate as a cold rolling step,
wherein the melt adjusting step is a step of loading aluminum metal comprising Cl: 0.00300 mass % or less to adjust the melt.

5. The method of producing the aluminum alloy plate for a magnetic disc substrate according to claim 4, wherein the melt adjusting step is a step of further loading a Cr raw material containing a Cr oxide: 0.50 mass % or less in the melt to adjust the melt.

6. A magnetic disc, comprising a plating layer and a magnetic layer on a surface of a circular aluminum alloy substrate prepared using the aluminum alloy plate for a magnetic disc substrate according to claim 1.
